(19) United States
(12) Patent Application Publication
(10) Pub. No.: US 2026/0003173 A1
(43) Pub. Date: Jan. 1, 2026

(54) Superresolving microscope with fast quasi-confocal detection and increased axial resolving power

(71) Applicant: Carl Zeiss Microscopy GmbH, Jena (DE)

(72) Inventors: Tiemo ANHUT, Jena (DE); Yauheni NOVIKAU, Jena (DE); Daniel SCHWEDT, Jena (DE); Matthias WALD, Jena (DE)

(73) Assignee: Carl Zeiss Microscopy GmbH, Jena (DE)

(21) Appl. No.: 19/252,033

(22) Filed: Jun. 27, 2025

(30) Foreign Application Priority Data
Jun. 30, 2024 (DE) 10 2024 118481.7

(51) Int. Cl. G02B 21/00; G02B 27/10; G02B 27/14; G02B 27/58

(52) U.S. Cl. CPC G02B 21/0032; G02B 21/0048; G02B 21/0072; G02B 21/008; G02B 27/1066; G02B 27/145; G02B 27/58

(57) ABSTRACT

Microscope with a linear illumination allows a fast image capture. The resolving power can be increased both transversely to the line by way of what is known as rescanning downstream of the confocal stop and along the line by way of illumination that is laterally structured also in this direction. Moreover, an increase in the resolving power in the direction of the optical axis should be made possible. To this end, the illumination beam path contains a beam shaper for creating a distribution of the illumination light in the sample space, said distribution being intensity-modulated along the optical axis and having a plurality of at least local intensity maxima along the optical axis.

### RELATED APPLICATION

The present application is a U.S. National Stage application of German Application No. DE 10 2024 118 481.7 filed on Jun. 30, 2024, the contents of which are herein incorporated by reference in their entirety.

### FIELD OF THE INVENTION

The invention relates to a microscope having an illumination beam path, a detection beam path and a beam splitter, wherein the detection beam path comprises a sample space, a microscope objective with an optical axis, a tube lens, an intermediate image created by the tube lens and a two-dimensionally spatially resolving optoelectronic sensor having a detection optics unit for imaging the intermediate image onto the sensor and the illumination beam path comprises a light source and a first settable beam deflection unit for moving an illumination light beam (“scanning”, “raster scanning”) through the sample space and the detection beam path comprises a second settable beam deflection unit for moving a sample light beam over the sensor, wherein the illumination beam path and the detection beam path are optically coupled to form a common beam path by means of the beam splitter such that illumination light from the light source passes via the beam splitter through the microscope objective into the sample space and sample light from the sample space passes through the microscope objective via the beam splitter and subsequently via the second beam deflection unit to the sensor, wherein the first beam deflection unit is optically arranged between the light source and the beam splitter such that the sample light away from the first beam deflection unit passes to the sensor, and having a control unit that is configured in one mode of operation to move the sample light beam over the sensor by means of the second beam deflection unit. In this case, the beam deflection units are arranged in, or at least near, a respective plane that is optically conjugate to a back focal plane of the microscope objective, which corresponds to a pupil plane of the microscope objective in the event of telecentric beam paths. The movement of the sample light beam over the sensor by means of the second beam deflection unit is initially fundamentally independent of a movement of the first beam deflection unit. Depending on the mode of operation, synchronization with the first beam deflection unit may be provided.

### BACKGROUND OF THE INVENTION

Confocal fluorescence imaging provides high-contrast, high-resolution images of biological samples. Like in DE 197 02 753 A1, the sample is scanned point-by-point by means of laser illumination via a beam deflection unit, and the created sample light is descanned by way of the same beam deflection unit such that a stationary beam from each sample location is present on the optical axis and detected by way of a confocal pinhole. As a result of this stop, the sensor is largely shielded from out-of-focus light, bringing about the high contrast. However, a comparatively long acquisition time on account of point-by-point scanning is disadvantageous. This inevitably also leads to a high phototoxic sample load due to the excitation light.

These disadvantages of point-by-point imaging can be reduced by parallelization. Examples of this are confocal microscopes having a Nipkow disc and light sheet microscopes, the latter requiring an additional illumination optics unit. In an alternative, parallelization can be achieved by means of linear illumination as in EP 1 617 258 A1. In order to achieve confocality at least in one dimension (transversely to the illumination line), linear detection using a slit-type stop is necessary here in order to suppress out-of-focus light. Along the line, the resolving power is comparable to a wide-field microscope.

To further increase the resolving power transversely to the line (superresolution beyond the diffraction limit), the sample light in the detection beam path can be rescanned following the descanning by the illuminating beam deflection unit, for the purposes of which a beam deflection unit is used to move said sample light over the sensor in the transverse direction downstream of the confocal stop (De Luca et al.: “Re-scan confocal microscopy: scanning twice for better resolution” in Biomedical Optics Express 2013. Vol. 4. No. 11, p. 2644). The pixels of the superresolved image of the sample must be calculated by linking intensities of different pixels at different times. The optical arrangement has the disadvantage of significant light losses on account of a large number of optical interfaces to be passed.

To increase the resolving power along the illumination line, the latter may additionally be structured in terms of its intensity (modulated) in its longitudinal direction during the rescan method (Shen et al.: “Confocal rescan structured illumination microscopy for real-time deep tissue imaging with superresolution” in Advanced Photonics Nexus 2023. Vol. 2 (1), p. 016009-1). In this case, each location on the sample must be illuminated in at least three different phases (different relative positions of the line structure) and imaged in a corresponding number of phase images. Like in the case of structured illumination microscopy (SIM) in the far field, the overall image must be calculated by linking all phase images (demodulation).

The low light sensitivity of the optical arrangements used in the rescan method is also retained with the structured illumination. Moreover, the arrangements are limited to the specific scanning microscopy method and hence inflexible. In particular, the confocal stop renders the system inflexible or at least complicated since said stop must be designed to be adjustable in mechanically highly accurate fashion in order to allow for a modicum of flexibility. Moreover, such mechanical settings tend to be slow.

DE102024108046 (subsequent publication) has disclosed a microscope of the type set forth at the outset that is improved over the aforementioned prior art and overcomes these disadvantages. However, like the aforementioned prior art, it still has the disadvantage of an axially increased extent of the illumination line and a correspondingly limited axial resolving power. Moreover, it is only possible to create two-dimensional superresolved images of the sample.

The problem addressed by the invention is that of improving a microscope of the type set forth at the outset such that an increase in the axial resolving power is also made possible. In special embodiments, it should moreover be possible to create three-dimensional images with at least lateral superresolution in two dimensions.

The problem is solved by a microscope having the features specified in claim 1.

Advantageous configurations of the invention are specified in the dependent claims.

According to the invention, provision is made for the illumination beam path to contain a beam shaper for creating a distribution of the illumination light in the sample space, said distribution being intensity-modulated along the optical axis and having a plurality of at least local intensity maxima along the optical axis. As a result of the axial intensity modulation, the illumination light distribution in the axial direction can be narrower in specific spatial regions in comparison with the axially unstructured linear illumination light distribution, and this allows for a higher axial resolving power. Moreover, this allows images of the sample to be calculated in three spatial dimensions with superresolution at least in the two lateral dimensions.

Embodiments in which the beam shaper comprises means for simultaneously creating at least three separate, coherent illumination light beams are advantageous, wherein the three illumination light beams interfere in the sample space in order to create the axially intensity-modulated distribution of the illumination light. In this case, the illumination light beams that interfere in the sample space preferably all reach the sample space via the first beam deflection unit. The interference of at least three illumination light beams is able to create particularly narrow intensity maxima along the optical axis (“axial”) (Talbot effect), whereby a particularly high axial resolving power is attained. In particular, one of the illumination light beams may be arranged centrally in the plane conjugate to the back focal plane of the microscope objective such that it makes use of the full numerical aperture of the microscope objective, leading to the best axial resolving power.

Three separate, coherent illumination light beams are created with great stability by virtue of the means for creating the illumination light beams comprising a first (beam shaper) beam splitter and a plurality of mirrors (preferably exactly two mirrors), wherein illumination light coming from the light source initially passes in a first direction to the first (beam shaper) beam splitter and is separated there into two partial beam paths with a respective optical axis. wherein the first partial beam path leaves the first (beam shaper) beam splitter in the first direction and the second partial beam path leaves said beam splitter in a second direction (that differs from the first direction), and the first partial beam path is deflected in such a way by the mirrors that it returns to the first (beam shaper) beam splitter in the opposite sense to the second direction, and the second partial beam path is deflected in such a way by the mirrors that it returns to the first (beam shaper) beam splitter in the opposite sense to the first direction. wherein the mirrors are arranged such that the optical axis of the first partial beam path when the first (beam shaper) beam splitter is reached again has a true parallel offset vis-à-vis the optical axis of the second partial beam path when leaving the first (beam shaper) beam splitter and in such a way that the optical axis of the second partial beam path when the first (beam shaper) beam splitter is reached again has a true parallel offset vis-à-vis the optical axis of the first partial beam path when leaving the first (beam shaper) beam splitter, wherein a second (beam shaper) beam splitter or one of the mirrors with a partially transmissive embodiment transmits a component of the first or of the second partial beam path to a reflector, or reflects said component out to said reflector, with said reflector reflecting the reflected-out component off its optical axis. As a result, the reflected-out or transmitted component returns to the first (beam shaper) beam splitter, and at least portions of said component leave said beam splitter in the opposite sense to the second direction as a central illumination light beam. After returning the first (beam shaper) beam splitter, the first and second partial beam paths leave the first (beam shaper) beam splitter again, at least in portions, as respective further illumination light beam in the same direction (in the opposite sense to the second direction) as the reflected-out component and in each case have a true parallel offset vis-à-vis the latter. In terms of construction, a (beam shaper) beam splitter is any desired beam splitter; the term merely serves to distinguish it from the beam splitter that couples the illumination beam path and the detection beam path. The first (beam shaper) beam splitter may be a neutral-intensity splitter in particular. in particular with a transmission of 50%.

In particular, the embodiment in which one of the mirrors is partially transmissive (and acts as a second (beam shaper) beam splitter in an alternative to the latter) allows for a uniform distribution of the light intensity among the three resultant illumination light beams should the first (beam shaper) beam splitter be a neutral-intensity splitter with a transmission of 50% and the partially transmissive mirror have a transmission of 62%. In that case, the transfer efficiency of the division into three illumination light beams is 28.5% overall. The central illumination light beam is less intense should the partially transmissive mirror have a transmission of 50% but an overall efficiency of 31.25% is achieved in return.

Three separate, coherent illumination light beams are created with greater light efficiency by virtue of the first (beam shaper) beam splitter taking the form of a polarization beam splitter, the first and second partial beam paths passing through a first half-wave plate between leaving the first (beam shaper) beam splitter and reaching it again, a quarter-wave plate being arranged between the second (beam shaper) beam splitter and the reflector and the first partial beam path passing through a second half-wave plate after leaving the first (beam shaper) beam splitter again in the opposite sense to the second direction. The first half-wave plate is inclined by 45° vis-à-vis the optical axes of the partial beam paths passing therethrough, in order to bring about a rotation of the polarization direction through 90°.

Three separate, coherent illumination light beams are created with great accuracy by virtue of the illumination light coming from the light source passing through a first rotationally symmetric optics unit before the first (beam shaper) beam splitter is reached for the first time and the three illumination light beams passing through a second rotationally symmetric optics unit after leaving the first (beam shaper) beam splitter again and by virtue of the illumination light passing through a cylinder optics unit before the first (beam shaper) beam splitter is reached for the first time or, alternatively, after it has been left again since each of the illumination light beams thus creates a respective ellipsoidal illumination light distribution of preferably the same size in the sample space. To this end, the focal planes of the first and second rotationally symmetric optics units may preferably coincide in the style of a 4f system.

At least one of the mirrors (preferably exactly two mirrors) can be movable, in particular along the first direction or along the second direction (one along the first direction and the other along the second direction in the event of two movable mirrors), with its orientation in space remaining constant. As a result, the distances between the outer illumination light beams (among themselves and in each case from the central illumination light beam) can be adjusted, whereby objective pupils of different sizes, for example, may be optimally illuminated in each case without requiring a zoom optics unit. By preference, the at least one movable mirror comprises a drive for this purpose. Advantageously, the reflector may be stationary.

The sample light passes to the sensor away from the first beam deflection unit; this may be referred to as non-descanned detection. In contrast with the known rescan microscopes, the movement of the first beam deflection unit is thus not undone, not even by the second beam deflection unit. The beams (sample light beams) successively emanating from different locations in the sample space on account of the scanning illumination are thus incident on each plane conjugate to the back focal plane of the microscope at correspondingly different angles with respect to the optical axis (and hence on the second beam deflection unit at different angles with respect to the optical axis). According to the invention, there is no stationary beam upstream of the second beam deflection unit. Surprisingly, it was determined that scanning of a beam that corresponds to rescanning is possible even with only exactly one beam deflection unit in the detection beam path. Accordingly, there is no stationary beam downstream of the second beam deflection unit either (in the first mode of operation); instead, the angle of the beam with respect to the optical axis after passing through the second beam deflection unit varies over time.

For the advantageous increase in the resolution, the angle of the direction of propagation of the beams coming from the sample space vis-à-vis the optical axis may even be increased by the second beam deflection unit. This method may be referred to as add scanning. For this purpose, the control unit may be configured in the first mode of operation to move the sample light beam in such a way over the sensor by means of the second beam deflection unit that the intermediate image is imaged in magnified fashion on the sensor. In particular, the movement may be such that an absolute value of a quotient between a first angle, which a direction of propagation of a beam of the sample light emanating from a location in the sample space directly downstream of the second beam deflection unit makes with an optical axis of the detection optics unit, and a second angle, which the direction of propagation of the beam directly upstream of the second beam deflection unit makes with an optical axis of the microscope objective, is greater than one.

The computational evaluation of the pixel intensities of the sensor at different times for the purpose of creating a superresolved image of the sample transversely to the longitudinal direction of the illumination line in this case corresponds to the known evaluation of pixel intensities that are acquired in descanned and rescanned fashion (and thereby the intermediate image imaged in magnified fashion on the sensor, preferably by the factor of two, in one dimension transversely to the longitudinal direction of the illumination line). The maximum increase in resolution transversely to the illumination line is attained with a magnification factor of two that is effective only in one dimension as a result of the add scan.

The magnification is obtained with little outlay by virtue of, at least in the first mode of operation, the movement of the second beam deflection unit being able to be synchronized or being synchronized with the movement of the first beam deflection unit, for example by the control unit or any other electrical connection. In particular, the control unit is able to move the first beam deflection unit and the second beam deflection unit with identical or approximately identical angular amplitude in order to attain the maximum increase in resolution by the add scan with the mechanical magnification by the factor of 2 effective only in one dimension.

The mechanical-technical requirements in respect of the second beam deflection unit are lower than in the case of the conventional rescan arrangements. It must merely meet the same requirements as the first beam deflection unit because-like the prior art-it need not scan an angular amplitude that is twice as large as those which could provide problems with the linearization and moreover would limit the overall acquisition speed, for example in the case of a galvanometer mirror.

Embodiments in which the illumination beam path comprises a beam shaper (for example a cylindrical lens) for creating a linear distribution of the illumination light (“illumination line”) are advantageous. In this case, the linear distribution may be intensity-modulated, in particular periodically intensity-modulated, along its longitudinal direction. By preference, such a distribution (“light pattern”) arises in the sample space by virtue of the beam shaper, for example comprising a spatial light modulator for this purpose, simultaneously creating at least two linear light distributions that are capable of interference with one another and present in a plane that is optically conjugate to a back focal plane of the microscope objective (BFP). As a result of the structuring along the illumination line, it is possible to increase the resolution transversely to the illumination line by virtue of raw images being acquired and evaluated in a plurality of phase angles of the modulated light distribution. By preference, the beam shaper creates the distribution of the illumination light in such a way that this gives rise in the sample space to a (modulated or unmodulated) illumination line which is imaged onto the pixel lines of the sensor by the detection beam path geometrically parallel to said pixel lines.

By preference, the beam shaper may be repeatedly removable from the illumination beam path, in particular in motor-driven fashion and under control by the control unit. As a result, the microscope can also be used with wide-field illumination in alternative modes of operation. The repeated motor-driven removability enables great flexibility. In an alternative to the removability or in addition thereto, the beam shaper may comprise a spatial light modulator (SLM), in particular a phase-modulating SLM, in a conjugate pupil plane (back focal plane of the microscope objective). In particular, the latter can be controlled by the control unit in such a way that different illumination light distributions arise in the sample space alternately in time. Hence it is possible to alternatively create an unmodulated linear illumination or, by means of at least three light distributions in the pupil plane/BFP capable of interference, a modulated linear illumination in the sample space. With a frequency of 50 Hz to 100 Hz for example, the changeover can occur very quickly by rewriting the phase pattern on the SLM. An SLM would also allow a quick switch over to a punctiform illumination in alternation with linear illumination, for example for optical manipulation in alternation with the observation of the sample. Advantageously, the first beam deflection unit may be settable in two dimensions for this purpose.

In particularly advantageous embodiments, the first beam deflection unit is designed for two-dimensionally scanning the sample space in a first dimension transverse to the longitudinal direction of the linear illumination light distribution and in a second dimension parallel to the longitudinal direction. As a result of the movement in the second dimension, the illumination light distribution can be brought into different phase angles with little outlay and in a short time, in order to be able to acquire the number of differently illuminated raw images that are required to increase the resolution. By preference, this purpose may be served by a control unit that places the first beam deflection unit in at least three different poses along the second dimension, wherein two of the resultant positions of the illumination light distribution in the sample space at the poses along the second dimension are spaced apart from each other by less than a length of the illumination light distribution in the longitudinal direction, in particular by a period length of the intensity-modulated light distribution or less than a period length, and wherein in particular a separate raw image is created for each of the poses.

In an alternative to the displacement of the light pattern along the (intensity-modulated) illumination line by the first beam deflection unit, such a displacement may be implemented by means of a pivotable, transparent, plane-parallel plate or by means of an electro-optic phase shifter, in each case in the illumination beam path. In an alternative to a displacement, the illumination beam path may comprise an optics unit for illuminating the sample space with different phase angles of the intensity-modulated illumination light distribution, in particular a spatial phase modulator (phase-influencing spatial light modulator) and/or an electro-optic modulator in combination with a quarter-wave plate. In this alternative. the first beam deflection unit may advantageously be designed for scanning the sample space only in one dimension transversely to the longitudinal direction of the linear illumination light distribution. A beam deflection unit that is only settable in one dimension is cheaper and especially more stable.

In comparison with conventional SIM image capture that requires 13 or even 15 raw images, a result image may be calculated using only three raw images. In this case, a region of interest (ROI) of the sample space at least in the longitudinal direction of the illumination line may be selected by means of the second dimension of the first beam deflection unit 21. A small region of interest can be scanned and acquired extremely quickly using the illumination line.

In all embodiments, the sensor, in particular a CMOS sensor, an EMCCD sensor. an iCCD sensor or a SPAD array sensor, may comprise a deactivatable line-shaped electronic light-control mechanism which is arranged confocally with the intermediate image. By preference, the electronic light-control mechanism may be realized in the form of an appropriately operated “rolling shutter”, for example like in WO 2006/008637 A1, in particular with a setting of the first beam deflection unit capable of being synchronized or being synchronized with a dynamic position (movement) of the stop at least in the first mode of operation (such that the relative position of the aperture of the electronic light-control mechanism corresponds to the relative position of the image representation of the illumination line from the sample space on the sensor). The electronic light-control mechanism allows a suppression of out-of-focus sample light and hence, like a mechanical confocal stop, allows an improvement in resolution both axially and laterally. An increase in the lateral resolution (transversely to the illumination line) is however also possible without confocal light-control mechanism/stop as a result of the magnified imaging by means of the second beam deflection unit. Out-of-focus light is also at least partially suppressed as a result of the calculation from a plurality of raw images in different illumination phase angles. The improvement in the axial resolving power is not influenced by the size of the light-control mechanism/stop. However, by way of the size of the light-control mechanism/stop, it is possible to weigh up the signal-to-noise ratio and the depth of focus against one another.

The advantage conferred by the use of a sensor with an electronic light-control mechanism is that it is possible to quickly switch between confocal and wide-field detection. for example between successive images.

For synchronization purposes, the sensor can preferably have a light sheet readout mode (as referred to by Hamamatsu) and have an output at which information about the position and/or movement of the light-control mechanism/stop is present, in particular a signal indicating a start of an image (“frame”) on the sensor. Commercially, sensors with such a mode and a corresponding output are available from Hamamatsu: https://www.hamamatsu.com/eu/en/product/cameras/cmos-cameras/lightsheet-readout-mode.html. The output is referred to by Hamamatsu as “external trigger output”. Advantageously, the control unit is electrically connected to the sensor and the beam deflection unit.

A microscope in which the control unit is electrically connected to the sensor and the beam deflection units and the electronic light-control mechanism is activated and the movements of the first beam deflection unit and of the second beam deflection unit and the movement of the electronic light-control mechanism are synchronized in the first selectable mode of operation, and/or the electronic light-control mechanism is activated, the movement of the first beam deflection unit and the movement of the electronic light-control mechanism are synchronized and the second beam deflection unit is operated in a constant pose, in particular in a neutral pose, in a second selectable mode of operation, and/or the electronic light-control mechanism is deactivated and the second beam deflection unit is operated in a constant pose in a third selectable mode of operation, and/or the electronic light-control mechanism is deactivated and the first and second beam deflection units are operated like in the first mode of operation in a fourth selectable mode of operation is particularly versatile.

Such a system may operate in a conventional wide-field mode (for example with incoherent illumination by way of a lamp as a light source, the illumination light of which is guided away, for example, from the first beam deflection unit, for example through a different output of the microscope, via the microscope objective into the sample space) or in the laser wide-field mode (third mode of operation) and in a confocal mode (second mode of operation) and in an add scanning mode (first and fourth modes of operation), without this requiring a mechanical modification to the system. Moreover, the sensor also enables quasi-simultaneously phase measurements (for example phase contrast, differential interference contrast, intensity transport equation, differential phase contrast) in further modes of operation. All that is required is to leave one or both beam deflection units in their rest position (neutral pose) and activate the electronic light-control mechanism and optionally set its size accordingly or deactivate it. This is implemented easily and quickly by the control unit, for example by software. This allows the realization of measurement tasks that would not be possible using a conventional rescan system. Especially in the case of multimodal recordings of the same sample, multiple use of the same sensor is generally advantageous since the data from the various measurements are then already aligned with one another with pixel accuracy. Moreover, the costs are lower because only one sensor is required for the various methods.

### SUMMARY OF THE INVENTION

An advantageous option may therefore consist in the control unit removing the beam shaper from the illumination beam path in the third mode of operation, and/or an intensity modulation of the illumination light being able to be deactivated or being deactivated in the second mode of operation (such that an unmodulated illumination line arises in the sample space), and/or the control unit comprising a selection unit for selecting one of a plurality of modes of operation, and the control unit operating the microscope in the selected mode of operation following the selection, in particular with an additional selection option in the selection unit between a plurality of sub-modes with in each case different light sources, in particular for the third mode of operation. This allows a flexible, cost-effective use with little operating outlay.

A microscope in which the detection beam path between the intermediate image created by the tube lens and the detection optics unit is free from confocal field stops, in particular from slot-type stops, and in particular is free from image planes conjugate to the intermediate image, and/or in which the detection beam path between the intermediate image created by the tube lens and the detection optics unit contains exactly one plane conjugate to the back focal plane of the microscope objective is advantageously compact and light-efficient.

A microscope can be constructed particularly compactly and light-efficiently by virtue of, optically between the intermediate image and the beam splitter, the common beam path comprising an optics unit, preferably a scan lens, for creating a plane conjugate to the back focal plane of the microscope objective on or near the first beam deflection unit and on or near the second beam deflection unit. As a result, on the one hand, the beam splitter is arranged in collimated light, and so possible contaminations have only a small influence on its transfer quality. On the other hand, this allows compact coupling of illumination and detection beam paths without the need-as in the prior art-for additional collimation. In particular, this can eliminate the need for an additional relay optics unit.

Particularly advantageously, the conjugate plane (pupil plane) may arise due to reflection off the beam splitter in this case, and so the first beam deflection unit is located in or near the reflected conjugate plane, in particular with transmission through the conjugate pupil plane into the detection beam path on or near the second beam deflection unit, and so the second beam deflection unit is located in or near the transmitted conjugate plane. In this way, no additional optics unit is required in the detection beam path; this keeps the number of optical interfaces to a minimum and thereby maximizes the light sensitivity of the detection. The transmission into the detection beam path leads (in comparison with an arrangement in reflection) to improved extinction of the excitation light, and so an improved contrast of the measurement signal to the excitation signal is attained at the detector.

By preference, both the illumination light on its path to the microscope objective and the sample light on its path to the sensor pass through the same intermediate image created by the tube lens. In this context, the beam splitter as main beam splitter or main colour splitter may be arranged optically between the first beam deflection unit and the intermediate image created by the tube lens.

Advantageously, only a single optical port of the microscope is occupied as a result of sharing the same intermediate image for illumination and detection. Possible further outputs are available for other uses, and so the microscope has even greater flexibility. In particular, fast quasi-confocal microscopy can be combined in a multimodal manner with other methods that require their own output. As a result, the arrangement according to the invention of illumination and detection beam paths, in each case to and from the intermediate image, respectively, or only of the detection beam path from the intermediate image to the sensor can advantageously be integrated into a single module, reducing the production and installation outlay and allowing a more compact and more stable construction, wherein, in the case of the combined module with illumination beam path and beam path, the actual light source may be arranged outside of the module and be optically connectable or connected thereto, for example by means of optical fibre(s) or free-beam input coupling into the module. In comparison with light sheet microscopes, moreover, this only requires a single illumination optics unit in the form of the microscope objective.

Alternatively, the microscope may comprise a second tube lens which creates a second intermediate image, wherein the illumination light on its path to the microscope objective passes through the second intermediate image (for example at a second optical port of the microscope). For example, an available laser scanning module may thus be used for illumination purposes. In that case, for example only the detection beam path as a dedicated module is linked to the first intermediate image at the first port of the microscope.

In a possible embodiment, the detection beam path between the beam splitter and the detection optics unit may comprise a secondary colour splitter that divides the sample light into two spectrally disjoint components and guides these to disjoint regions on the sensor or to a respective sensor (for example like in DE 10 2021 134 427 A1 or DE 10 2023 005 252 A1), and the illumination beam path may comprise a second light source with a different emission wavelength to the first light source. In this way, two spectral ranges, in particular of two different fluorescent dyes, associated with the emission wavelengths can be acquired simultaneously. The first and the second light source may be the same light source, for example in the form of a multiline laser or a broadband light source, in particular a white light source. For precise structuring, the two colours may advantageously be superimposed on one another at the first beam deflection unit, with the grating constants of the illumination pattern in the sample being identical.

Advantageously, the first beam deflection unit comprises MEMS micromirrors, in particular MEMS micromirrors that are adjustable continuously about two orthogonal spatial directions. As a result, a module (having illumination and detection beam paths, in each case up to the intermediate image, or only the detection beam path from the intermediate image) may be provided compactly, quietly and cost-effectively. Two-dimensionally adjustable MEMS scanners are moreover advantageous in that the deflection mirror is always located in the optical pupil/BFP, and this optimizes the placement accuracy of the illumination focus volume. In particular, the second axis may also be used to displace the illumination line along its longitudinal direction in order to create the different illumination phase angles of a structured illumination. Furthermore, this allows the illumination region to be defined and/or a longer (modulated or unmodulated) or more homogeneous (unmodulated) line to be created. Moreover, the second axis may be used to create very small movements along the illumination line, and these movements homogenize the line illumination (without SIM mode). Finally, this also guarantees a good image field illumination if the sample is manipulated optically by way of the first beam deflection unit.

As an alternative to a two-dimensionally adjustable MEMS micromirror, the first beam deflection unit may be formed conventionally from two mirrors that are each adjustable in one dimension, in particular galvanometer mirrors, preferably with an optical relay that images the one mirror onto the other.

Embodiments in which the microscope comprises a stand on which the microscope objective is arranged, in particular in an objective turret, wherein the stand comprises a first port, in the region of which the tube lens and the intermediate image are arranged, and at least one further port having a further tube lens and a further intermediate image, wherein the sample light can be guided simultaneously or sequentially to both outputs by means of at least one second beam splitter, in particular a repeatedly removable beam splitter, or by means of a mirror, wherein the first beam splitter, the detection optics unit, the sensor, the first and the second beam deflection unit and a scan lens are arranged within a module that is optically and mechanically detachably connected to one of the ports are particularly preferred. This allows the provision of a flexibly usable microscope system with great light sensitivity at a short acquisition time.

In a further embodiment, the invention also comprises a microscope having an evaluation unit which receives a plurality of raw images from at least two, in particular three, preferably five, different phase angles of the illumination light distribution in the sample space, in particular from different planes of the sample space, and calculates a result image with an increased resolution in three spatial directions from the raw images, in particular a three-dimensional image, in particular by solving a system of equations that describes the convolution of an unknown sample with point spread functions for illumination and detection for the various phase angles, in particular also for the different sample space planes, in the spatial or frequency domain.

The invention is explained in more detail below on the basis of exemplary embodiments.

### BRIEF DESCRIPTION OF THE DRAWINGS

In the drawings:

FIG. 1A, FIG. 1B, and FIG. 1C each show characteristic properties of different illumination variants,

FIG. 2A and FIG. 2B shows further characteristic properties of an illumination having three interfering light beams,

FIG. 3 shows a microscope,

FIG. 4 shows the optical conditions in the microscope,

FIG. 5 shows a beam shaper for creating three illumination light beams capable of interference,

FIG. 6 shows an alternative beam shaper,

FIG. 7 shows an alternative microscope, and

FIG. 8 shows principles of the control and synchronization regime.

### DETAILED DESCRIPTION OF THE INVENTION IN CONNECTION WITH THE DRAWINGS

In all of the drawings, corresponding parts bear the same reference signs.

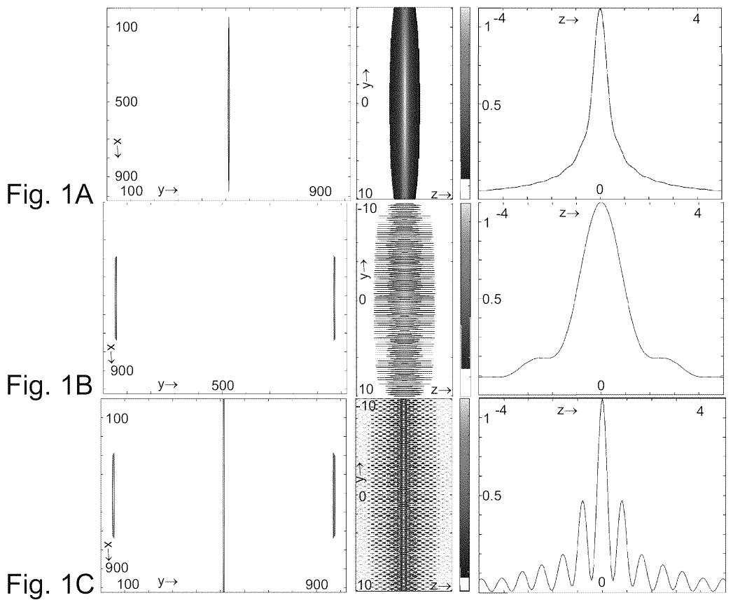

FIG. 1A shows, by way of example, a simulated linear light distribution in the pupil created by means of a cylindrical lens (left), a yz-section of the simulated light distribution in the sample-side focal plane (centre) and an axial section through this sample-side light distribution (right), where y denotes the coordinate along the longitudinal direction of the linear illumination in the sample space and z is the axial coordinate, plotted here from −5 mm to 5 mm. The image region here and hereinafter always has units of μm. In this and the following simulations, the following parameters were assumed: λ=550 nm, NA=1.4, n=1.51, and y-polarization. Since focusing is only performed in one spatial direction, the excitation line has a finite axial extent.

FIG. 1B shows the corresponding representations for a simulated linear light distribution with intensity modulation along the longitudinal direction of the illumination line. aiming for a two-dimensional structured illumination as in DE102024108046. Two linear light distributions with true parallel offset that interfere in the sample space, resulting in a modulation in the longitudinal direction of the line there, are created in the pupil. It is evident both from the yz-section (centre) and the axial section (right) that the illumination light distribution in the sample space is broadened in the axial direction in comparison with the simple line in FIG. 1A, reducing the axial resolving power.

A distribution of the illumination light in the sample space, with an intensity modulation according to the invention along the optical axis and with a plurality of local intensity maxima along the optical axis, can be achieved in particular by radiating in a third illumination line that interferes accordingly with the two other lines. In a manner corresponding to FIGS. 1A and 1B, FIG. 1C shows a simulated light distribution in the pupil (left) and a yz-section (centre) and also an axial section (right) of the light distribution in the sample-side focal plane of the microscope objective, which has a three-dimensional structuring that is modulated laterally and also axially in this case. In this case, the local maxima, especially the central local maximum, are significantly narrower in the axial direction than in the other two cases. The axial resolving power is therefore significantly better than in the other two cases should this type of illumination be used for three-dimensional SIM.

An essential prerequisite for 3-D SIM is that the structurings in the lateral and axial direction factorize; see equation (3) in Gustafsson et al., doi:10.1529/biophysj.107.120345.

This makes the assumption that the actual light distribution, which arises due to the interference of the light distribution components in the system pupil, is approximated by a product of a line PSF and an axial Talbot grating pattern. It is evident from FIG. 1C that this prerequisite is met.

In order to be able to use optimally efficient processing, only exactly one defined modulation frequency may be present in the axial direction (likewise see Gustafsson et al.). For the paraxial case (small NA) and for the focal plane, this can be shown by virtue of the product of the light distributions in the pupil for the generation of a line PSF and a Talbot grating pattern being identical to the creation of a grating pattern by way of the interference of the 3 orders (illumination light beams) in the pupil according to FIG. 1C:

$$\begin{matrix}{\vert F [ ] \vert}^{2} * {\vert F [ ] \vert}^{2} = F [ ] * {F}^{*} [ ] * F [ ] * {F}^{*} [ ] \\ = [ F [ ] * F [ ] ] * [ {F}^{*} [ ] * {F}^{*} [ ] ] \\ = {FF}^{- 1} [ F [ ] * F [ ] ] * {FF}^{- 1} [ {F}^{*} [ ] * {F}^{*} [ ] ] \\ = F [ ] {F}^{*} [ ] = {\vert F [ ] \vert}^{2}\end{matrix}$$

Here, F represents a Fourier transform and F⁻¹ represents a corresponding inverse transformation.

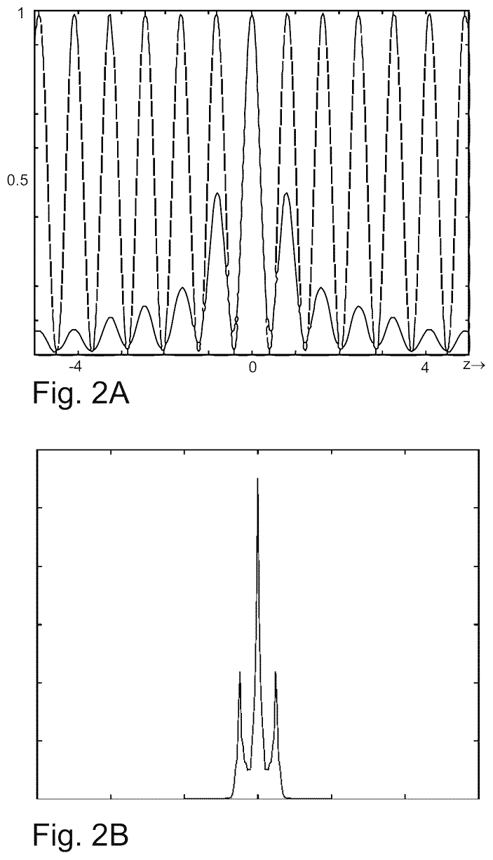

This relationship is illustrated in FIG. 2A, which contains the simulated axial section from FIG. 1C (right) as a solid line and the single harmonic (1+cos(a z)) as a dashed line, in conjunction with FIG. 2B, which reproduces the frequency spectrum of the solid curve. It is evident in both partial figures that only exactly one harmonic is present in the simulated light distribution. In any case, the requirement for only one harmonic is not strictly applicable. The resultant light distribution in the sample space may also contain a plurality of harmonics, i.e. a plurality of modulation frequencies. However, this renders the processing of the data more complicated and more protracted.

Under the assumption of a grating pattern factorized from the illumination light pattern in the x-direction and the illumination light pattern in the z-direction, the three-dimensional illumination light pattern may be formulated as follows:

$${I}_{ex} ( x , y , z ) = I ( y , z ) \{ {a}_{0} + {a}_{2} cos ( 2 {\hat{k}}_{y} y + 2 φ ) + {a}_{1} cos ( {\hat{k}}_{y} y + φ ) * cos ( ( \hat{k} - {\hat{k}}_{z} ) z - {φ}_{0} ) \}$$

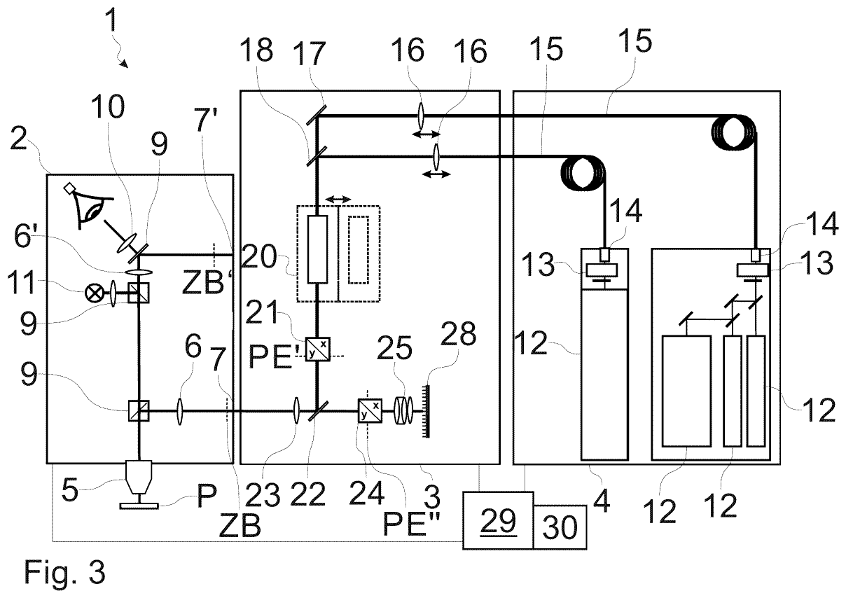

FIG. 3 shows a schematic illustration of a microscope 1 with which the above-described illumination light distribution structured in three-dimensionally modulated fashion may be used to perform 3-D SIM. It consists of a stand 2, an add-scan module 3 and a laser module 4. The stand 2 comprises a microscope objective 5, for example a telecentric microscope objective, having tube lenses 6, which each create an intermediate image ZB in the region of two outputs 7/7′. The microscope objective 5 is arranged on an objective turret that has not been depicted separately. The stand also comprises beam splitters 9 capable of being pivoted-in, for example neutral-intensity splitters or colour splitters, in order to guide light proportionally in selectively configurable fashion to the outputs and/or to the eyepiece 10 and/or to guide light from a lamp 11 to the microscope objective 5 and from there into the sample space P. In the sample space, the sample is located on a stage that is displaceable in three dimensions in motor-driven fashion but not depicted for the sake of clarity.

Purely by way of example, the laser module 4 comprises four lasers 12 with different emission wavelengths, the respective intensity of which can be set by means of a respective AOTF 13. In an alternative (not shown), one or more of the lasers may be directly modulable. Their illumination light is input coupled into optical fibres 15 via coupling optics units 14 and guided to the scan module 3, where it is collimated by means of longitudinally displaceable collimators 16, for example. The collimators 16 may serve to compensate for chromatic longitudinal aberrations and/or to focus the illumination light at different depths in the sample space P. In an alternative (not shown), the different emission wavelengths may for example already be combined in the laser module such that only a single optical fibre 15 is required, and it is possible to manage without collimators 16. By way of a mirror 17 and a beam combiner 18, the illumination light combined thus reaches a deflection mirror 19 which deflects the illumination light in such a way that, following the passage through a beam shaper 20, which for example comprises a phase-modifying spatial light modulator (SLM) and a cylindrical lens. said illumination light is incident on the first beam deflection unit 21, for example a continuously two-dimensionally settable micro-electromechanical system (MEMS) with micromirrors. From the beam splitter 22, the illumination light passes via the scan lens 23, the intermediate image ZB and one of the tube lenses 6 to the microscope objective 5 and from there into the sample space P. Since the beam shaper 20 focuses the illumination light in one dimension into the plane conjugate with the pupil of the microscope objective 5 and located on the beam deflection unit 21, a fundamentally linear illumination focus volume (illumination line) arises in the sample space. Using the SLM, the illumination light can be modified such that it forms three separate points or three truly parallel lines, like in FIG. 1C, on the first beam deflection unit arranged in the conjugate pupil plane PE′, with said three separate points or truly parallel lines interfering in the sample space such that the illumination focus volume is illuminated along its longer extent (longitudinal direction of the illumination line) with a periodic intensity pattern that is also periodically modulated along the optical axis of the microscope objective 5, wherein a local intensity maximum is located in the sample-side focal plane of the microscope objective 5. In this case, the period of the axial modulation is shorter than the axial full width at half maximum of the unmodulated illumination light and also shorter than the axial full width at half maximum of a conventional illumination line that is modulated purely laterally (not axially) and results from only two illuminated points or only two illuminated lines in the pupil, with the result that the adjacent minima constrict the local maximum to a significantly reduced full width at half maximum.

Sample light, in particular also fluorescence fundamentally excited in linear fashion by the illumination light in the sample, passes in the reverse direction via the intermediate image ZB to the beam splitter 22. The component of the illumination light reflected in the sample and on the way there is reflected back to the first beam deflection unit 21 by the beam splitter 22, which for example is designed as a dichroic notch filter and hence acts as a main colour splitter. Fluorescence contained in the sample light is transmitted, in particular due to the Stokes shift, through the beam splitter 22 to the second beam deflection unit 24, for example an only one-dimensionally continuously settable MEMS mirror or a galvanometer mirror. The first scan lens 23 that collimates the sample light is designed such that a plane PE″ conjugate to the pupil PE of the microscope objective 5 is located firstly on the first beam deflection unit 21 and secondly on the second beam deflection unit 24. Downstream of the second beam deflection unit 24, the sample light is focused by a detection optics unit 25 onto the two-dimensionally spatially resolving sensor 28, for example a CMOS chip or a matrix of single photon-counting avalanche photodiodes (SPAD array). In the neutral position (zero position) of the second beam deflection unit 24, the optical axes of the microscope objective 5 and of the detection optics unit 25 coincide. The sensor 28 comprises an electronic slot-type light-control mechanism in the form of a rolling shutter, the slot width of which is settable and which is completely deactivatable. The illumination line in the sample space is aligned such that it is imaged onto the sensor 28 parallel to the pixel lines thereof (and hence parallel to the electronic slot-type light-control mechanism).

A control unit 29 with a selection unit 30 for e.g. four different modes of operation (with further sub-modes) is electrically connected to the stand 2, the add-scan module 3 and the laser module 4. It firstly controls the mechanical and optical components contained therein and secondly receives measurement values from the contained sensors, in particular from the sensor 28.

Should the user select the first mode of operation (“add-scan mode”), the control unit 29 activates the electronic light-control mechanism of the sensor 28 and moves the sample light beam coming from the sample space over the sensor 28 by means of the second beam deflection unit 24 such that the intermediate image ZB is imaged onto the sensor 28 with magnification in the movement direction, wherein said control unit synchronizes the movement of the second beam deflection unit 24 with the movement of the first beam deflection unit 21 and moves both of these with e.g. an identical angular amplitude. The movement of the beam deflection units 21. 24 is moreover synchronized with the movement of the electronic slot-type light-control mechanism of the sensor 28 by means of the control unit 29, with the result that said slot-type light-control mechanism acts as a confocal stop, and the illumination focus volume is imaged into the slot-type light-control mechanism aperture.

In this case, the sample light incident on the second beam deflection unit 24 already has an angle of incidence (in relation to the optical axis of the microscope objective 5) that depends on the origin in the sample space. The synchronization of the first beam deflection unit 21 and of the second beam deflection unit 24 amplifies this effect. As a result of the identical amplitude and the chosen in-phase vibration direction, the sample light reflected off the second beam deflection unit 24 has an angle twice the size in relation to the optical axis of the detection optics unit 25. In a conventional system, this angle would be zero on account of the descanning performed there; the sample light beam would be stationary.

The increase in the angle results in a one-dimensional magnification transversely to the illumination line, a “non-optical” anisotropic magnification by a factor of M_{mech}=2 in the case of doubling due to identical amplitudes of the beam deflection units 21/24, and this magnification is added to a potential purely optical (typically isotropic) magnification Mₒₚₜ by the detection optics unit 25 in conjunction with the scan lens 23. This leads firstly to a corresponding broadening of the point spread function (PSF) but secondly also to the distance on the sensor 28 between two points of the sample space imaged onto the sensor 28 being increased to a greater extent than the increase in the width of the PSF, corresponding to a reassignment or rescanning. The image recorded on the sensor 28 must be compressed (back projected) one-dimensionally by a factor of M_{mech} in the direction transversely to the illumination line in order to correctly reproduce the proportions of the sample space. Since the imaged points were spread to an extent that was greater than the broadening of the PSF, a better resolution than for a comparable diffraction-limited wide-field image representation remains despite the compression in the transverse direction—directly optically-mechanically without complex reconstruction calculations. By contrast, the resolution in the longitudinal direction of the illumination line is not influenced in this respect.

The second beam deflection unit 24 acts in the direction transversely to the illumination line as set forth below. The image representation Irec of a fluorescent object S(x, y, z) in the sample space in the object-side focal plane of the microscope objective on the sensor 28 may be described using a convolution, wherein the optical magnification may be assumed as Mopt=1 without loss of generality:

$${I}_{rec} ( x , y , z ) = \int {dx}^{′} {dy}^{′} {dz}^{′} S ( x - {x}^{′} , {y}^{′} , z - {z}^{′} ) {H}_{eff} ( {x}^{′} , y , {y}^{′} , {z}^{′} ) \qquad ( 1 )$$

For the sake of compactness, the non-optical magnification M_{mech} is simply denoted as M here. H_{eff}(x′, y, y′, z′) is the intensity point spread function for imaging objects in the object plane into the detection plane on the sensor 28.

In the case of a linear detection and a general illumination light distribution Iₑₓ, the effective PSF can be written as:

$${H}_{eff} ( x - {x}^{′} , y , {y}^{′} , {z}^{′} ) = \int {dx}^{″} D ( Mx - {Mx}^{″} ) {I}_{ex} ( {x}^{′} - {x}^{″} , {y}^{′} , {z}^{′} ) {H}_{em} ( Mx - {x}^{′} - ( M - 1 ) {x}^{″} , y - {y}^{′} , {z}^{′} )$$

A substitution \hat{x}=x′−x″→x″=x′−\hat{x} leads to

$${H}_{eff} ( x - {x}^{′} , y , {y}^{′} , {z}^{′} ) = \int d \hat{x} D ( M ( x - {x}^{′} ) + M \hat{x} ) {I}_{ex} ( \hat{x} , {y}^{′} , {z}^{′} ) {H}_{em} ( M ( x - {x}^{′} ) + ( M - 1 ) \hat{x} , y - {y}^{′} , {z}^{′} )$$

In that case, a further substitution x−x′→x′ leads to

$${H}_{eff} ( {x}^{′} , y , {y}^{′} , {z}^{′} ) = \int d \hat{x} D ( {Mx}^{′} + M \hat{x} ) {I}_{ex} ( \hat{x} , {y}^{′} , {z}^{′} ) {H}_{em} ( {Mx}^{′} + ( M - 1 ) \hat{x} , y - {y}^{′} , {z}^{′} )$$

Hence, for the case D=1, the following measured intensity is obtained as an image representation of a three-dimensional fluorescence emitted distribution S:

$${I}_{rec} ( x , y , z ) = \int {dx}^{′} {dy}^{′} {dz}^{′} S ( x - {x}^{′} , {y}^{′} , z - {z}^{′} ) \int d \hat{x} {I}_{ex} ( \hat{x} , {y}^{′} , {z}^{′} ) {H}_{em} ( {Mx}^{′} + ( M - 1 ) \hat{x} , y - {y}^{′} , {z}^{′} )$$

The case M_{mech}=1 describes a stationary second beam deflection unit 24, while M_{mech}=2 means that the second beam deflection unit 24 vibrates with the same angular amplitude and optically in the same sense as the first beam deflection unit 21 that moves the illumination line through the sample space. For M_{mech}=0, the second beam deflection unit 24 compensates the effect of the first beam deflection unit 21.

For further considerations there is a move to the Fourier space since the data are preferably also processed using this model. The Fourier transform of the measured intensity is

$${\tilde{I}}_{em}^{} ( {k}_{x} , {k}_{y} , {k}_{z} ) = \int {dk}_{y}^{′} {dk}_{z}^{′} \tilde{S} ( {k}_{x} , {k}_{y} - {k}_{y}^{′} , {k}_{z} ) {\tilde{I}}_{ex}^{} ( \frac{( M - 1 ) {k}_{x}}{M} , {k}_{y}^{′} , {k}_{z} - {k}_{z}^{′} ) {\tilde{H}}_{em} ( \frac{{k}_{x}}{M} , {k}_{y} , {k}_{z}^{′} )$$

The rescaling of the spatial frequency kₓ created by the add scan effect along the x-axis is evident here. A Fourier transform of the illumination light pattern formulated above with respect to FIG. 2 yields

$$\begin{matrix}{\tilde{I}}_{ex} ( {k}_{x}^{′} , {k}_{y}^{′} , {k}_{z}^{′} ) = {a}_{0} δ ( {k}_{y}^{′} ) \tilde{I} ( {k}_{x}^{′} , {k}_{z}^{′} ) \\ + {a}_{2} \tilde{I} ( {k}_{x}^{′} , {k}_{z}^{′} ) \{ δ ( {k}_{y}^{′} + 2 {\hat{k}}_{y} ) {e}^{2 i φ} + δ ( {k}_{y}^{′} - 2 {\hat{k}}_{y} ) {e}^{- 2 i φ} \} \\ + {a}_{1} \{ δ ( {k}_{y}^{′} + {\hat{k}}_{y} ) {e}^{i φ} + δ ( {k}_{y}^{′} - {\hat{k}}_{y} ) {e}^{- i φ} \} \\ * \{ \tilde{I} ( {k}_{x}^{′} , {k}_{z}^{′} + [ {\hat{k}}_{z} - \hat{k} ] ) {e}^{i {φ}_{0}} + \tilde{I} ( {k}_{x}^{′} , {k}_{z}^{′} - [ {\hat{k}}_{z} - \hat{k} ] ) {e}^{- i {φ}_{0}} \}\end{matrix}$$

As a result of the Fourier transform, the calculations can be performed efficiently numerically. Hence, the following is obtained in the Fourier space for the intensity

$${\tilde{I}}_{rec}^{}$$

recorded at the sensor 28:

$${\tilde{I}}_{rec}^{} ( {k}_{x} , {k}_{y} , {k}_{z} ) = {a}_{0} \tilde{S} ( {k}_{x} , {k}_{y} , {k}_{z} ) \int {dk}_{z}^{′} \tilde{I} ( \frac{( M - 1 ) {k}_{x}}{M} , {k}_{z} - {k}_{z}^{′} ) {\tilde{H}}_{rec} ( \frac{{k}_{x}}{M} , {k}_{y} , {k}_{z}^{′} ) + {a}_{2} \{ \tilde{S} ( {k}_{x} , {k}_{y} + 2 {\hat{k}}_{y} , {k}_{z} ) {e}^{2 i φ} + \tilde{S} ( {k}_{x} , {k}_{y} - 2 {\hat{k}}_{y} , {k}_{z} ) {e}^{- 2 i φ} \} * \int {dk}_{z}^{′} \tilde{I} ( \frac{( M - 1 ) {k}_{x}}{M} , {k}_{z} - {k}_{z}^{′} ) {\tilde{H}}_{rec} ( \frac{{k}_{x}}{M} , {k}_{y} , {k}_{z}^{′} ) + {a}_{1} \{ \tilde{S} ( {k}_{x} , {k}_{y} + {\hat{k}}_{y} , {k}_{z} ) {e}^{i φ} + \tilde{S} ( {k}_{x} , {k}_{y} - {\hat{k}}_{y} , {k}_{z} ) {e}^{- i φ} \} * \int {dk}_{z}^{′} \{ \tilde{I} ( \frac{( M - 1 ) {k}_{x}}{M} , {k}_{z} - {k}_{z}^{′} + [ {\hat{k}}_{z} - \hat{k} ] ) {e}^{i {φ}_{0}} + \tilde{I} ( \frac{( M - 1 ) {k}_{x}}{M} , {k}_{z} - {k}_{z}^{′} - [ {\hat{k}}_{z} - \hat{k} ] ) {e}^{- i {φ}_{0}} \} {\tilde{H}}_{rec} ( \frac{{k}_{x}}{M} , {k}_{y} , {k}_{z}^{′} )$$

This transformed intensity in the Fourier space is now composed of the components for the 0th, 1st and 2nd orders. In this case,

$$( \frac{{k}_{x}}{M} , {k}_{y} , {k}_{z}^{′} )$$

is the Fourier transform of the PSF of the detection, i.e. the detection OTF. The effective OTF for the 0th order is given by

$$\int {dk}_{z}^{′} \tilde{I} ( \frac{( M - 1 ) {k}_{x}}{M} , {k}_{z} - {k}_{z}^{′} ) {\tilde{H}}_{rec} ( \frac{{k}_{x}}{M} , {k}_{y} , {k}_{z}^{′} )$$

and the OTF components of the 1st and 2nd orders are given analogously.

The functions \tilde{S}(kₓ, k_{y}, k_{z}) describe the Fourier transforms of the object, which for the higher orders in the Fourier space are displaced by ±\hat{k}_{y} for the 1st order and ±2\hat{k}_{y} for the 2nd order. The 1st order moreover also comprises the corresponding components for the axial structuring.

The model describes how the measured intensity or its Fourier transform

$${\tilde{I}}_{rec}^{} ( {k}_{x} , {k}_{y} , {k}_{z} )$$

is composed of the various orders. In this case, 5 unknown functions \tilde{S}(kₓ, k_{y}, k_{z}), \tilde{S}(kₓ, k_{y}+2\hat{k}_{y}, k_{z}), . . . that describe the object S arise, wherein in this case higher frequency components than in the case of the Oth order, which would describe the imaging without structured illumination, also arise in the higher orders. Now, 5 measurements are performed in order to ascertain these unknowns, with the phase parameter φ selectable in the experiment being modified between said measurements and a respective raw image being recorded. Then, a system of equations for ascertaining the unknown functions should be solved for each pixel. There exist a number of sufficiently well-known algorithms for this purpose, such as certain deconvolutions, etc. It is moreover evident that no further equation needs to be solved for the y-direction. All that occurs is coordinate rescaling within the sense of the add-scan method in this case, i.e. the image is compressed by the appropriate value in a manner dependent on the scanner deflection of the second beam deflection unit 24. If the second beam deflection unit 24 runs with the same amplitude synchronously with the first beam deflection unit 21, then the raw image is compressed in the x-direction by a factor of 2. Rescaling and the 3-D SIM calculation are independent of one another. Therefore, the compression can be implemented before or after the SIM calculation. Both are possible.

Advantageously, the confocal light-control mechanism/stop can be used to suppress stray light components far away from the focus. In this case, D is not identical to 1 but set to a sensible value. All calculations of the improved resolution are not affected thereby for as long as data from the vicinity of the focus are also detected for the 3-D SIM calculation. In this case, the add-scan method has the advantage of an easily adjustable confocal light-control mechanism/stop, which for example may optionally be added in the case of thick samples.

The additional structured illumination (as a result of intensity modulation along the line and axially along the optical axis of the microscope objective 5) thus serves to increase the resolution in the longitudinal direction of the illumination line and along the optical axis. To this end, the control unit 29 puts the first beam deflection unit 21 into at least two, preferably five, different poses along the longitudinal direction of the illumination line, with the result that adjacent resultant positions (phase angles) in the sample space are spaced apart from one another by less than a period length of the intensity-modulated light distribution, and creates a separate raw image of the sample space for each of the poses. Expediently, the region of interest in the sample space is initially fully scanned for each of these phase angles of the illumination pattern, and a respective raw image with an increased resolution in one dimension (transversely to the line) is created. This process is repeated with the second phase angle and optionally up to the fifth phase angle; a similar procedure is carried out for different planes of the sample space that are offset in the axial z-direction. A result image with increased resolution is then calculated from the raw images according to the known 3-D SIM method. This is the calculation known per se, for example by solving the system of equations. The calculation differs from the 3-D SIM method known per se merely by way of the above-described OTF or PSF that has been modified for the different orders. The above-described compression by M_{mech} transversely to the illumination line for the back projection may in this case be implemented before or after the SIM reconstruction (for example comprising a transformation of the raw images into the frequency domain, a separation of order spatial frequency spectra and a shift of the order spatial frequency spectra in the frequency domain and an inverse transformation into the spatial domain; for example, see Shen et al., in Advanced Photonics Nexus 2023. Vol. 2 (1), p. 016009-1, sections 2.1 and 2.2, and Gustafsson et al. for the extension to three dimensions) because the structuring along the illumination line and the reconstruction of the increased resolution in this direction are independent of the additional scan transverse to the illumination line. Prior to the superresolving SIM reconstruction, the raw images may be subject to high-pass filtering. preferably in the frequency domain following the Fourier transform, in order to reduce out-of-focus background by optical sectioning within the sense of an OS-SIM treatment (Neil et al.: “Method of obtaining optical sectioning by using structured light in a conventional microscope” in Optics Letters 1997. Vol. 22. No. 24, p. 1905). The control unit may be configured to calculate the result image with an increased resolution, in particular in accordance with the aforementioned steps. The sample data may also be reconstructed using fewer than five illumination phases, but it is not possible to obtain the full gain in resolution in that case.

In particular, the modified PSF may be used for a deconvolution that further improves the resolution.

Should the user choose the second mode of operation, the control unit 29 activates the electronic light-control mechanism, synchronizes the movement of the first beam deflection unit 21 and the movement of the electronic light-control mechanism but keeps the second beam deflection unit 24 constant in its neutral position and deactivates the intensity modulation. This mode allows image captures like with a conventional line-scanning confocal microscope. In the third mode of operation, the control unit 29 deactivates the electronic light-control mechanism and also keeps the second beam deflection unit 24 in its neutral position. Conventional wide-field image captures are possible with this. In this context, the user may use the lamp 11 as a wide-field light source as an alternative to the lasers 12.

In a fourth selectable mode of operation, the control unit 29 deactivates the electronic light-control mechanism and operates the first and second beam deflection units 21, 24 like in the first mode of operation. This mode allows the use of the add-scan method with less suppression of the out-of-focus light. However, the calculation of the result image from the structured raw images also suppresses out-of-focus light to a certain extent. Since a light-control mechanism/stop is not mandatory, a sensor 28 may also be used without this.

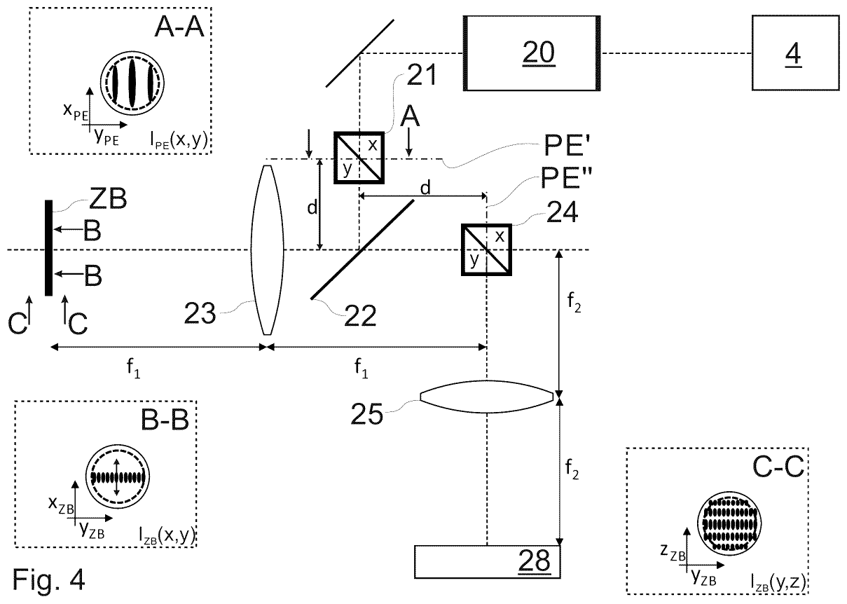

FIG. 4 shows exemplary optical conditions as a result of the focal length f₁ of the scan lens 23 and the focal length f₂ of the detection optics unit 25. In this case, both the first beam deflection unit 21 and the second beam deflection unit 24 are arranged at an identical distance d from the beam splitter 22, and so the two units are located in a respective conjugate pupil plane PE′ and PE″, respectively. The ratio of the focal lengths Mₒₚₜ=f₂/f₁ describes the optical magnification of the intermediate image ZB on the sensor 28. Additionally, there is the one-dimensional mechanical magnification M_{mech} as a result of the movement of the second beam deflection unit 24, which in the event of an in-phase movement synchronous with the first beam deflection unit 21 arises as M_{mech}=(α₁+α₂)/α₁ from the ratio of the angular amplitudes α₁ of the first beam deflection unit 21 and α₂ of the second beam deflection unit 24. Depicted as section A-A is also the effect of the beam shaper 20 on the illumination pattern with the intensity distribution I_{PE}(x,y) in the illumination-side conjugate pupil plane PE′ in the first mode of operation. It consists of three separate, parallel lines which as a result of the Fourier transform brought about by the scan lens 23 interfere in the intermediate image ZB to form a laterally and axially periodically modulated line grating pattern with the intensity distribution I_{ZB}(x,y,z), which is transferred into the sample space by the tube lens 6 and the microscope objective 5. A double-headed arrow in the section B-B through the intermediate image ZB indicates the movement of the line grating pattern in the x_{ZB}-direction for the purpose of scanning the sample by means of the first beam deflection unit 21. For example, the different illumination phases are achieved by adjusting the first beam deflection unit 21, in such a way that the line grating pattern is offset in the y_{ZB}-direction, preferably by less than one period of the line grating pattern. The section C-C depicts the axial modulation of the resultant light distributions (along the z-direction) in the intermediate image ZB.

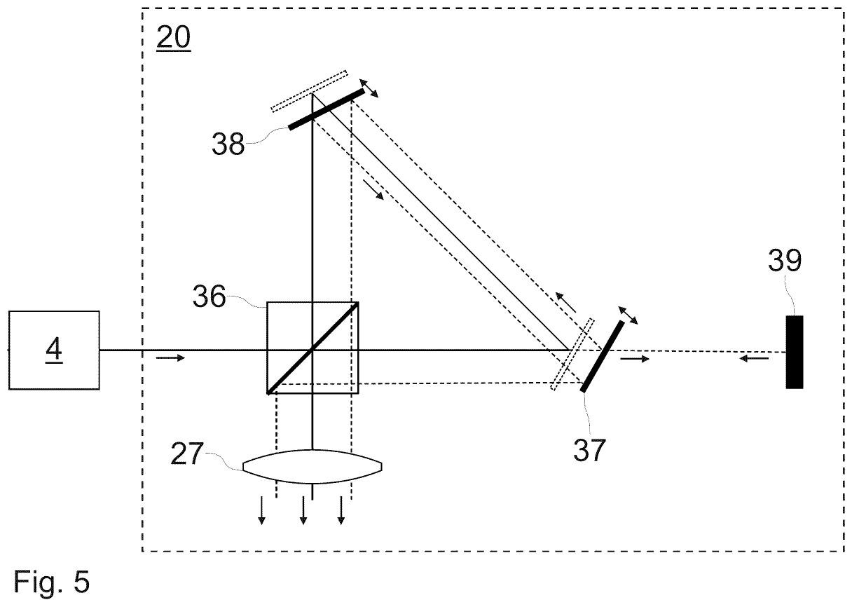

FIG. 5 represents a preferred embodiment of a beam shaper 20 which may be used as an alternative to the SLM used in FIG. 1. It produces three separate, coherent illumination light beams. It comprises a first (beam shaper) beam splitter 36 designed as a neutral-intensity splitter with a transmission of 50%, a first mirror 37, a second mirror 38, a reflector 39 and a cylindrical optics unit 27 and is constructed similarly to a Sagnac interferometer. For example, the reflector 39 is also a mirror.

Illumination light coming from the light source 4 reaches the first (beam shaper) beam splitter 36 in a first direction and is separated there into two partial beam paths with a respective optical axis. Arrows indicate the direction of propagation of the respective partial beam path. The first partial beam path leaves the first (beam shaper) beam splitter 36 in the first direction (for example to the right in the drawing). The second partial beam path leaves the first (beam shaper) beam splitter 36 in a second direction (for example upwards in the drawing). The first partial beam path is deflected in such a way by the mirrors 37. 38 such that it returns to the first (beam shaper) beam splitter 36 in the opposite sense to the second direction. The second partial beam path is deflected in such a way by the mirrors 38. 37 such that it returns to the first (beam shaper) beam splitter 36 in the opposite sense to the first direction. The mirrors are arranged such that the optical axis of the first partial beam path when the first (beam shaper) beam splitter 36 is reached again has a true parallel offset vis-à-vis the optical axis of the second partial beam path when leaving the first (beam shaper) beam splitter 36 and in such a way that the optical axis of the second partial beam path when the first (beam shaper) beam splitter 36 is reached again has a true parallel offset vis-à-vis the optical axis of the first partial beam path when leaving the first (beam shaper) beam splitter 36.

For example, the mirrors 37, 38 are movable by means of a drive while retaining their spatial orientation; this is indicated by double-headed arrows. The reflector 39 is stationary. Movement of the mirrors 37, 38 allows the spacing of the partial beam paths following the renewed departure from the first (beam shaper) beam splitter 36 to be set. As a result of the symmetric displacement of the mirrors 37, 38, the spacings of the partial beam paths also remain symmetrical.

In contrast to a Sagnac interferometer, the first mirror 37 is partially transmissive with a transmission of for example 62%, and so a component of the first partial beam path is transmitted to the reflector 39, which reflects off its optical axis the transmitted component. As a result, the transmitted component returns to the first (beam shaper) beam splitter 36, and portions of said component leave said beam splitter in the opposite sense to the second direction as a central illumination light beam, which is linear on account of the cylindrical optics unit 27 in the pupil PE′. Components of the first and second partial beam paths leave the first (beam shaper) beam splitter 36 as respective further illumination light beam in the same direction. Each of these have a true parallel offset from the central illumination light beam and are linear on account of the cylindrical optics unit 27 in the pupil PE′.

The transfer efficiency of the split into three illumination light beams up to the cylindrical optics unit 27 is 28.5% overall in this case; the three illumination light beams have an identical intensity

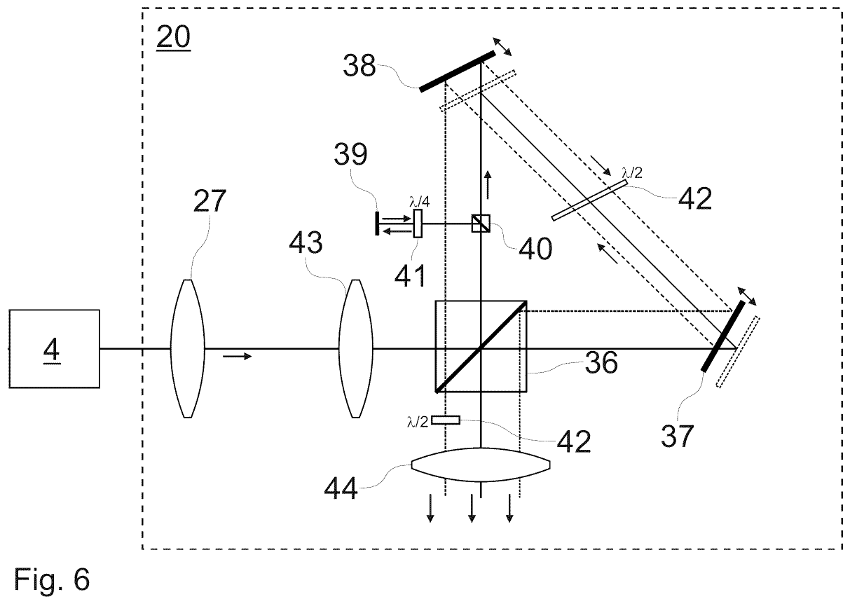

The alternative beam shaper 20 depicted in FIG. 6 has a similar construction to that shown in FIG. 5 but has a higher overall transfer efficiency. In this case, the first (beam shaper) beam splitter 36 takes the form of a polarization beam splitter and the first mirror 37 is opaque (transmission 0%). Instead, a second (beam shaper) beam splitter 40 is arranged between the first (beam shaper) beam splitter 36 and the second mirror 38 and reflects-out a component of for example 50% of the second partial beam path by way of a quarter-wave plate 41, once again to a reflector 39 that reflects off its optical axis the reflected-out component. Additionally, a respective half-wave plate 42 at an angle of 45°, which rotates the polarization through 180°, is arranged in the common path of the first and second partial beam paths between the two mirrors 37, 38 and in the first partial beam path following the renewed departure from the first (beam shaper) beam splitter. The functional principle corresponds to the beam shaper 20 depicted in FIG. 5.

A cylindrical optics unit 27 and a first rotationally symmetric optics unit 43 are arranged upstream of the first (beam shaper) beam splitter 36 in the illumination direction. The three illumination light beams pass through a second rotationally symmetric optics unit 44 after leaving the first (beam shaper) beam splitter 36 again, and so each of the illumination light beams creates a respective ellipsoidal illumination light distribution of the same size in the sample space. To this end, the focal planes of the first and second rotationally symmetric optics units 43, 44 in particular coincide in the style of a 4f system.

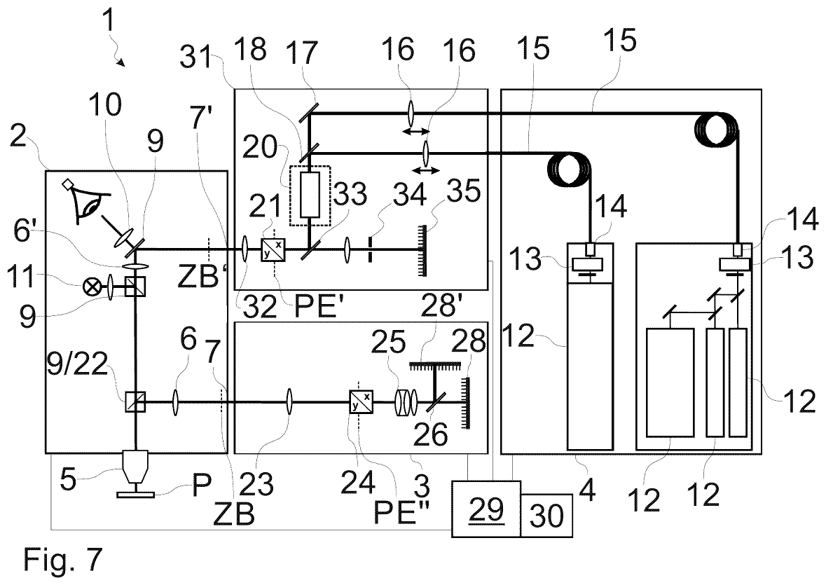

FIG. 7 shows an alternative embodiment in which the illumination beam path is provided by a separate laser scanning module 31. The latter comprises a dedicated scan lens 32, a main beam splitter 33, a slot-type stop 34 and a line scan detector 35 in addition to the beam shaper 20 and the first beam deflection unit 21. The module 31 provides a linear light distribution in the sample space, like in FIG. 1. In this case, the add-scan module 3 only comprises portions of the detection beam path (from the intermediate image ZB up to the sensors 28). Between the beam splitter 22 and the detection optics unit 25, it comprises a secondary colour splitter 26 that divides the sample light into two spectrally disjoint components and guides these to a respective sensor 28, 28′. For example, the control unit 29 activates two lasers 12 with different emission wavelengths in order to be able to simultaneously record two fluorescent dyes. Since the beam splitter 22 expediently takes the form of a colour splitter like in FIG. 1, it is not possible to use the line scan detector 35 in this mode of operation as no sample light reaches it (instead, said sample light is guided into the add-scan module).

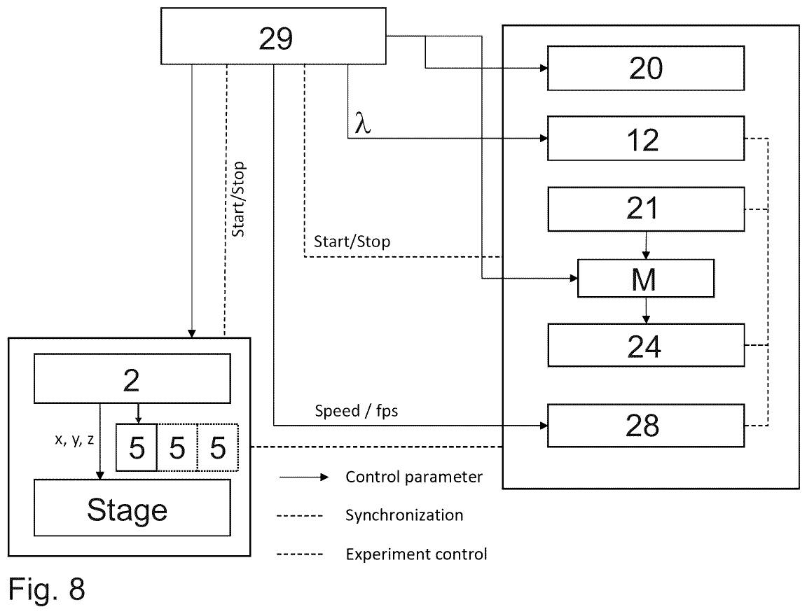

FIG. 8 schematically illustrates the connections and tasks of the control unit 29 and the synchronization in the first mode of operation. For example, the beam deflection units 21, 24 are thus synchronized with the sensor 28. The control unit 29 can set the magnification factor M by virtue of changing the ratio of the amplitudes of the beam deflection units 21, 24. By way of the control unit 29, it is also possible to displace the sample stage or select one of a plurality of microscope objectives 5 from the objective turret.

### LIST OF REFERENCE SIGNS AND USED ABBREVIATIONS

1 Microscope
2 Stand
3 Add-scan module
4 Laser module
5 Microscope objective
6 Tube lenses
7 Output
8
9 Beam splitter
10 Eyepiece
11 Lamp
12 Laser
13 AOTF
14 Input coupling optics unit
15 Optical fibre
16 Collimator
17 Mirror
18 Beam combiner
19 Deflection mirror
20 Beam shaper
21 First beam deflection unit
22 Main beam splitter
23 Scan lens
24 Second beam deflection unit
25 Detection optics unit
26 Secondary colour splitter
27 Cylindrical optics unit
28 Sensor
29 Control unit
30 Selection unit
31 Laser scanning module
32 Scan lens
33 Main beam splitter
34 Slot-type stop
35 Line scan detector
36 (Beam shaper) beam splitter
37 First mirror
38 Second mirror
39 Reflector
40 Second (beam shaper) beam splitter
41 Quarter-wave plate
42 Half-wave plate
43 First rotationally symmetric optics unit
44 Second rotationally symmetric optics unit
P Sample space
ZB Intermediate image
PE Pupil plane
PE′(′) Conjugate pupil plane

Add new last par.

1. Microscope comprising an illumination beam path, a detection beam path and a beam splitter, wherein the detection beam path comprises a sample space, a microscope objective with an optical axis, a tube lens, an intermediate image created by the tube lens and a two-dimensionally spatially resolving optoelectronic sensor having a detection optics unit for imaging the intermediate image onto the sensor and the illumination beam path comprises a light source and a first settable beam deflection unit for moving an illumination light beam through the sample space and the detection beam path comprises a second settable beam deflection unit for moving a sample light beam over the sensor, wherein the illumination beam path and the detection beam path are optically coupled to form a common beam path by means of the beam splitter such that illumination light from the light source passes via the beam splitter through the microscope objective into the sample space and sample light from the sample space passes through the microscope objective via the beam splitter and subsequently via the deflection unit is optically arranged between the light source and the beam splitter such that the sample light away from the first beam deflection unit passes to the sensor, and having a control unit that is configured in one mode of operation to move the sample light beam over the sensor by means of the second beam deflection unit, wherein the illumination beam path comprises a beam shaper for creating a distribution of the illumination light in the sample space, said distribution being intensity-modulated along the optical axis and having a plurality of local intensity maxima along the optical axis.

2. Microscope according to claim 1, wherein the beam shaper comprises means for simultaneously creating three separate, coherent illumination light beams, wherein the three illumination light beams interfere in the sample space in order to create the axially intensity-modulated distribution of the illumination light.

3. Microscope according to claim 1, wherein the means for creating the illumination light beams comprise a first (beam shaper) beam splitter and a plurality of mirrors, wherein illumination light coming from the light source initially passes in a first direction to the first (beam shaper) beam splitter and is separated there into two partial beam paths with a respective optical axis, wherein the first partial beam path leaves the first (beam shaper) beam splitter in the first direction and the second partial beam path leaves said beam splitter in a second direction (that differs from the first direction), and the first partial beam path is deflected in such a way by the mirrors that it returns to the first (beam shaper) beam splitter in the opposite sense to the second direction, and the second partial beam path is deflected in such a way by the mirrors that it returns to the first (beam shaper) beam splitter in the opposite sense to the first direction, wherein the mirrors are arranged such that the optical axis of the first partial beam path when the first (beam shaper) beam splitter is reached again has a true parallel offset vis-à-vis the optical axis of the second partial beam path when leaving the first (beam shaper) beam splitter and in such a way that the optical axis of the second partial beam path when the first (beam shaper) beam splitter is reached again has a true parallel offset vis-à-vis the optical axis of the first partial beam path when leaving the first (beam shaper) beam splitter, wherein a second (beam shaper) beam splitter or one of the mirrors with a partially transmissive embodiment transmits a component of the first or of the second partial beam path to a reflector, or reflects said component out to said reflector, with said reflector reflecting the reflected-out or transmitted component off its optical axis.

4. Microscope according to claim 3, wherein the first (beam shaper) beam splitter takes the form of a polarization beam splitter, the first and second partial beam paths pass through a first half-wave plate between first leaving the first (beam shaper) beam splitter and reaching it again, a quarter-wave plate is arranged between the second (beam shaper) beam splitter and the reflector and the first partial beam path passes through a second half-wave plate after leaving the first (beam shaper) beam splitter again in the opposite sense to the second direction.

5. Microscope according to claim 4, wherein the illumination light coming from the light source passes through a cylinder optics unit before the first (beam shaper) beam splitter is reached for the first time or after it has been left again, in particular wherein the illumination light coming from the light source passes through a first rotationally symmetric optics unit before the first (beam shaper) beam splitter is reached for the first time and the three illumination light beams pass through a second rotationally symmetric optics unit after leaving the first (beam shaper) beam splitter again.

6. Microscope according to claim 5, wherein at least one of the mirrors is movable, along the first direction or along the second direction, with its orientation in space remaining constant.

7. Microscope according to claim 6, wherein the control unit is configured in the first mode of operation to move the sample light beam in such a way over the sensor by means of the second beam deflection unit that the intermediate image is imaged in magnified fashion on the sensor, by way of a movement such that an absolute value of a quotient between a first angle, which a direction of propagation of a beam of the sample light emanating from a location in the sample space directly downstream of the second beam deflection unit makes with an optical axis of the detection optics unit, and a second angle, which the direction of propagation of the beam directly upstream of the second beam deflection unit makes with an optical axis of the microscope objective, is greater than one.

8. Microscope according to claim 7, wherein the movement of the second beam deflection unit can be synchronized or is synchronized with the movement of the first beam deflection unit at least in the first mode of operation, with an identical or approximately identical angular amplitude of the first beam deflection unit and of the second beam deflection unit.

9. Microscope according to claim 8, wherein the illumination beam path comprises a beam shaper for creating a linear distribution of the illumination light, in particular a distribution with an intensity modulation along the longitudinal direction thereof, in particular a distribution with a periodic intensity modulation, in particular such a distribution in the sample space due to the simultaneous creation of at least two linear light distributions that are capable of interference with one another and present in a plane that is optically conjugate to a back focal plane of the microscope objective.

10. Microscope according to claim 9, wherein the beam shaper is repeatedly removable from the illumination beam path, in particular in motor-driven fashion and controlled by the control unit, and/or comprises a spatial light modulator, in particular controlled by the control unit such that different illumination light distributions arise in the sample space alternately in time.

11. Microscope according to claim 5, wherein the first beam deflection unit is designed for two-dimensionally scanning the sample space in a first dimension transverse to a longitudinal direction of the linear illumination light distribution and in a second dimension parallel to the longitudinal direction, in particular with a control unit that places the first beam deflection unit in at least three different poses along the second dimension, wherein two of the resultant positions of the illumination light distribution in the sample space at the poses along the second dimension are spaced apart from each other by less than a length of the illumination light distribution in the longitudinal direction, in particular by a period length of the intensity-modulated light distribution or less than a period length, and in particular a separate raw image is created for each of the poses.

12. Microscope according to claim 5, wherein the illumination beam path comprises an optics unit for illuminating the sample space with different phase angles of the intensity-modulated illumination light distribution, in particular a spatial phase modulator and/or an electro-optic modulator in combination with a quarter-wave plate, in particular with an embodiment of the first beam deflection unit for scanning the sample space only in one dimension transversely to a longitudinal direction of the linear illumination light distribution.

13. Microscope according to claim 7, wherein the sensor, in particular a CMOS sensor or a SPAD sensor, comprises a deactivatable line-shaped electronic light-control mechanism which is arranged confocally with the intermediate image, in particular in the form of a rolling shutter, in particular with the capability of synchronizing a setting of the first beam deflection unit with a dynamic position of the light-control mechanism.

14. Microscope according to claim 13, wherein the control unit is electrically connected to the sensor and the beam deflection units, and the electronic light-control mechanism is activated and the movements of the first beam deflection unit and of the second beam deflection unit and the movement of the electronic light-control mechanism are synchronized in the first selectable mode of operation, and/or the electronic light-control mechanism is activated, the movement of the first beam deflection unit and the movement of the electronic light-control mechanism are synchronized and the second beam deflection unit is operated in a constant pose, in particular in a neutral pose, in a second selectable mode of operation, and/or the electronic light-control mechanism is deactivated and the second beam deflection unit is operated in a constant pose in a third selectable mode of operation, and/or the electronic light-control mechanism is deactivated and the first and second beam deflection units are operated like in the first mode of operation in a fourth selectable mode of operation.

15. Microscope according to claim 14, wherein the control unit removes the beam shaper from the illumination beam path in the third mode of operation, and/or an intensity modulation of the illumination light can be deactivated or is deactivated in the second mode of operation, and/or the control unit comprises a selection unit for selecting one of a plurality of modes of operation, and the control unit operates the microscope in the selected mode of operation following the selection, in particular with an additional selection option in the selection unit between a plurality of sub-modes with in each case different light sources, for the third mode of operation.

16. Microscope according to claim 15, wherein the detection beam path between the intermediate image created by the tube lens and the detection optics unit is free from confocal field stops, from slot-type stops, and in particular is free from image planes conjugate to the intermediate image, and/or wherein the detection beam path between the intermediate image created by the tube lens and the detection optics unit contains exactly one plane conjugate to the back focal plane of the microscope objective.

17. Microscope according to claim 16, wherein, optically between the intermediate image and the beam splitter, the common beam path comprises an optics unit preferably a scan lens, for creating a plane (PE′) conjugate to the back focal plane of the microscope objective on or near the first beam deflection unit and on or near the second beam deflection unit.

18. Microscope according to claim 17, wherein both the illumination light on its path to the microscope objective and the sample light on its path to the sensor pass through the same intermediate image created by the tube lens (6), in particular with the optical arrangement of the beam splitter as main beam splitter or as main colour splitter between the first beam deflection unit and the intermediate image created by the tube lens (6), or wherein the microscope comprises a second tube lens (6′) that creates a second intermediate image, and the illumination light passes through the second intermediate image on its path to the microscope objective.

19. Microscope according to claim 18, wherein the detection beam path between the beam splitter and the detection optics unit comprises a secondary colour splitter that divides the sample light into two spectrally disjoint components and guides these to disjoint regions on the sensor or to a respective sensor, with a second light source in the illumination beam path with an emission wavelength that differs from the first light source.

20. Microscope according to claim 19, wherein the first beam deflection unit comprises MEMS micromirrors that are adjustable continuously about two orthogonal spatial directions.

21. Microscope according to claim 1, wherein the microscope comprises a stand on which the microscope objective is arranged, wherein the stand comprises a first port, in the region of which the tube lens and the intermediate image are arranged, and at least one further port having a further tube lens and a further intermediate image, wherein the sample light can be guided simultaneously or sequentially to both outputs by means of at least one second beam splitter, which is a repeatedly removable beam splitter, or by means of a mirror, wherein the first beam splitter, the detection optics unit, the sensor, the first and the second beam deflection unit and a scan lens are arranged within a module that is optically and mechanically detachably connected to one of the ports.

22. Microscope according to claim 1, comprising an evaluation unit which receives a plurality of raw images from at least two, preferably five, different phase angles of the illumination light distribution in the sample space, in particular from different planes of the sample space, and calculates a result image with an increased resolution in three spatial directions from the raw images, in particular a three-dimensional image, by solving a system of equations that describes the convolution of an unknown sample with point spread functions for illumination and detection for the various phase angles, also for the different sample space planes, in the spatial or frequency domain.
